(19) United States
(12) Patent Application Publication
(10) Pub. No.: US 2024/0120542 A1
(43) Pub. Date: Apr. 11, 2024

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Tae Hyon BAE, Yongin-si (KR); Harim LEE, Yongin-si (KR); Sanghyung KIM, Yongin-si (KR); Seunghyeon SON, Yongin-si (KR); Arum YU, Yongin-si (KR); Yunhee KIM, Yongin-si (KR)

(21) Appl. No.: 18/304,217

(22) Filed: Apr. 20, 2023

(30) Foreign Application Priority Data
Sep. 21, 2022 (KR) 10-2022-0119526

(51) Int. Cl. H01M 10/0567; H01M 10/0525; H01M 10/0568; H01M 50/46

(52) U.S. Cl. CPC H01M 10/0567; H01M 10/0525; H01M 10/0568; H01M 50/46; H01M 2300/0025

(57) ABSTRACT

An electrolyte for a rechargeable lithium battery, and rechargeable lithium battery including the same are disclosed. The electrolyte includes a non-aqueous organic solvent, a lithium salt, and an additive, wherein the additive includes a fluorinated ketone and an Ag salt.

### CROSS-REFERENCE TO RELATED APPLICATION

This application claims priority to and the benefit of Korean Patent Application No. 10-2022-0119526, filed in the Korean Intellectual Property Office on Sep. 21, 2022, the entire content of which is incorporated herein by reference.

### BACKGROUND

### 1. Field

An electrolyte for a rechargeable lithium battery and a rechargeable lithium battery including the same are disclosed.

### 2. Description of the Related Art

A rechargeable lithium battery may be recharged and has at least three times more energy density per unit weight as compared to a related art lead storage battery, nickel-cadmium battery, nickel hydrogen battery, nickel zinc battery and/or the like. It may be also charged at a high rate and thus, is commercially manufactured for a laptop, a cell phone, an electric tool, an electric bike, and/or the like, and researches on improvement of additional energy density have been actively made.

A rechargeable lithium battery may be manufactured by injecting an electrolyte into a battery cell, which includes a positive electrode including a positive electrode active material capable of intercalating/deintercalating lithium ions and a negative electrode including a negative electrode active material capable of intercalating/deintercalating lithium ions. The electrolyte may include an organic solvent in which a lithium salt is dissolved and critically affects or determines stability and performance of a rechargeable lithium battery.

Recently, to satisfy a need for a high-capacity and high-energy density battery, a battery drivable at a high voltage of about 4.5 V or higher, while an electrode is highly densified, is being pursued, and improvement of high-rate charging performance of the battery is also desired. However, under harsh conditions such as high voltage and high-rate charging, the positive electrode may be deteriorated, and lithium dendrite may grow on the surface of the negative electrode, which may accelerate a side reaction between the electrodes and the electrolyte and thus deteriorate battery cycle-life and cause a battery safety problem due to gas generation and/or the like.

In order to solve the problem, methods to suppress or reduce the side reaction with the electrolyte by surface-treating the electrodes for protection have been proposed. However, the surface treatment of the positive electrode showed insufficient protection effect during the high voltage driving conditions, and the surface treatment of the negative electrode has been reported to have a problem of deteriorating capacity. Accordingly, in the design of high-capacity electrodes capable of driving at a high voltage and high-rate charging, an electrolyte capable of improving safety and performance of batteries is desired.

On the other hand, techniques for improving impregnability of an electrolyte by applying an ester-based solvent with low viscosity to the electrolyte to suppress or reduce the lithium dendrite of the negative electrode have been proposed. However, the ester-based solvent has low oxidation resistance and strong inflammability (e.g., low flammability) and thus may have disadvantages of poor battery performance and safety at a high voltage.

### SUMMARY

Aspects according to embodiments of the present disclosure are directed toward an electrolyte capable of suppressing the generation of lithium dendrites in the negative electrode by improving the impregnation of the negative electrode and uniformizing the intercalation of lithium ions on the surface of the negative electrode.

Aspects according to embodiments of the present disclosure are directed toward a rechargeable lithium battery with improved high-rate charging performance, high-temperature cycle-life characteristics, and safety by including the electrolyte.

According to an embodiment, an electrolyte for a rechargeable lithium battery includes a non-aqueous organic solvent, a lithium salt, and an additive, wherein the additive includes a fluorinated ketone and an Ag salt.

The fluorinated ketone may be represented by Chemical Formula 1.

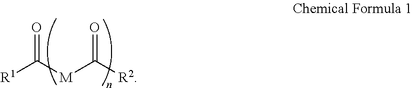

In Chemical Formula 1, M may be a substituted or unsubstituted C1 to C30 alkylene group, a substituted or unsubstituted C2 to C30 alkenylene group, or a substituted or unsubstituted C2 to C30 alkynylene group, n may be an integer of 0 to 5, and

R¹ and R² may each independently be a substituted or unsubstituted C1 to C30 alkyl group, a substituted or unsubstituted C2 to C30 alkenyl group, a substituted or unsubstituted C2 to C30 alkynyl group, a substituted or unsubstituted C3 to C20 cycloalkyl group, or a substituted or unsubstituted C6 to C20 aryl group, provided that at least one of R¹ or R² includes at least one fluorine (F) atom.

The M of Chemical Formula 1 may be a substituted or unsubstituted C1 to C30 alkylene group, R¹ and R² may each independently be a substituted or unsubstituted C1 to C10 alkyl group, a substituted or unsubstituted C2 to C10 alkenyl group, or a substituted or unsubstituted C2 to C10 alkynyl group, provided that at least one of R¹ or R² includes at least one fluorine atom and n may be 0 or 1.

At least one of R¹ or R² in Chemical Formula 1 may be a C1 to C10 fluoroalkylene group in which at least one hydrogen is substituted with a fluorine atom.

At least one of R¹ or R² in Chemical Formula 1 may be a C1 to C10 fluoroalkylene group substituted with 3 to 21 fluorine atoms.

At least one of R¹ or R² in Chemical Formula 1 may be a C1 to C10 perfluoroalkylene group in which all hydrogens are substituted with fluorine atoms.

The fluorinated ketone may be represented by Chemical Formula 1-1:

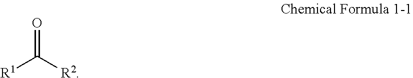

In Chemical Formula 1-1,

R¹ and R² may each independently be a substituted or unsubstituted C1 to C30 alkyl group, provided that at least one of R¹ or R² includes at least one fluorine atom.

At least one of R¹ or R² may be a C1 to C10 perfluoroalkyl group in which all hydrogens are substituted with fluorine atoms.

R¹ and R² may be functional groups different from each other, and Chemical Formula 1-1 may have an asymmetric structure.

The fluorinated ketone may be represented by Chemical Formula 1-2 or Chemical Formula 1-3.

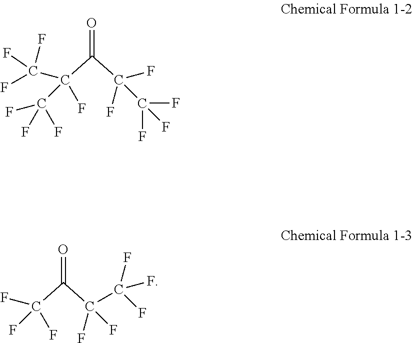 [SMILES: O=C(C(F)(F)C(F)(F)F)C(F)(C(F)(F)F)C(F)(F)F ; O=C(C(F)(F)F)C(F)(F)C(F)(F)F]

The fluorinated ketone may be about 1.0 wt % to about 10.0 wt % in amount based on a total weight of the electrolyte.

The Ag salt may include one or more selected from the group consisting of AgNO₃, AgPF₆, AgFSI, AgTFSI, AgF, AgSO₃CF₃, AgBF₄, AgNO₂, AgN₃, and AgCN.

The Ag salt may be about 0.1 wt % to about 10.0 wt % in amount based on a total weight of the electrolyte.

A weight ratio between the fluorinated ketone and the Ag salt may be about 4:6 to about 9:1. The electrolyte may further include a compound represented by Chemical

Formula 2.

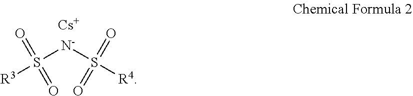

In Chemical Formula 2,

R³ and R⁴ may each independently be a fluoro group or a substituted C1 to C10 fluoroalkyl group including at least one fluorine atom.

The compound represented by Chemical Formula 2 may be represented by Chemical Formula 2-1 or Chemical Formula 2-2.

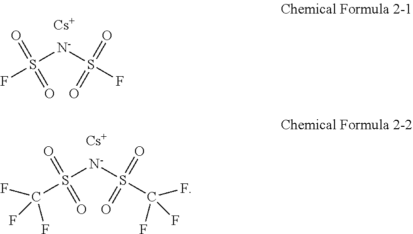

The compound represented by Chemical Formula 2 may be about 0.1 wt % to about 5.0 wt % in amount based on a total weight of the electrolyte.

A weight ratio between the fluorinated ketone and the compound represented by Chemical Formula 2 may be about 4:6 to about 9:1.

The additive may be about 1.0 wt % to about 30.0 wt % in amount based on a total weight of the electrolyte.

The electrolyte for a rechargeable lithium battery may further include one or more other additives, and the one or more other additives may include at least one selected from the group consisting of vinylene carbonate (VC), fluoroethylene carbonate (FEC), difluoroethylene carbonate (DFEC), chloroethylene carbonate (CEC), dichloroethylene. carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propene sultone (PST), propane sultone (PS), lithium tetrafluoroborate (LiBF₄), lithium difluorophosphate (LiPO₂F₂), 2-fluorobiphenyl (2-FBP), lithium difluorooxalate borate (LiDFOB), and lithium bisoxalate borate (LiBOB).

According to another embodiment, a rechargeable lithium battery includes a positive electrode including a positive electrode active material, a negative electrode including a negative electrode active material, a separator between the positive electrode and the negative electrode, and the aforementioned electrolyte.

The negative electrode may have a density of greater than or equal to about 1.6 g/cc.

The electrolyte for a rechargeable lithium battery according to an embodiment may improve impregnability of the negative electrode and uniformly insert lithium ions into the surface of the negative electrode, thereby suppressing occurrence of lithium dendrites in the negative electrode.

A rechargeable lithium battery according to an embodiment may have improved high-rate charging performance, high-temperature cycle-life characteristics, and stability by including the electrolyte for a rechargeable lithium battery.

### BRIEF DESCRIPTION OF THE DRAWINGS

FIG. 1 is a schematic view illustrating a rechargeable lithium battery according to an embodiment.

FIG. 2 is a graph showing a discharge capacity retention rate of a rechargeable lithium battery cells according to evaluation of high-temperature cycle-life characteristics.

### DETAILED DESCRIPTION

Hereinafter, embodiments will be described in more detail so that those skilled in the art can easily implement them. However, this disclosure may be embodied in many different forms and should not be construed as limited to the example embodiments set forth herein.

In the present specification, it will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, the term “layer” as used herein includes not only a shape formed on the whole surface when viewed from a plan view, but also a shape formed on a partial surface.

In the present specification, “at least one of A, B, or C”, “one of A, B, C, or a combination thereof” and even “one of A, B, C, and a combination thereof” (based on context) may each indicate only A, only B, only C, both (e.g., simultaneously) A and B, both (e.g., simultaneously) A and C, both (e.g., simultaneously) B and C, all of A, B, and C, or variations thereof.

As used herein, the term “or” is not to be construed as an exclusive meaning, for example, “A or B” is construed to include A, B, A+B, and/or the like. Hereinafter, the term “combination” includes a mixture of two or more, a composite of two or more, a copolymer of two or more, an alloy of two or more, a blend of two or more, mutual substitution, and a laminated structure of two or more.

As utilized herein, when a definition is not otherwise provided, the term “substituted” refers to replacement of hydrogen atom of a substituent or a compound by a substituent selected from deuterium, a halogen, a hydroxyl group, an amino group, a substituted or unsubstituted C1 to C30 amine group, a nitro group, a substituted or unsubstituted C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof. In addition, as a non-limiting example, the term “substituted” may refer to replacement of hydrogen atom of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group, for example, a fluoro group, a chloro group, a bromo group, an iodo group, a methyl group, an ethyl group, a propyl group, or a butyl group, and for example, a fluoro group, a chloro group, a bromo group, or an iodo group.

Herein, expressions such as C1 to C30 refer to that the number of carbon atoms is 1 to 30.

In some embodiments, the average particle diameter may be measured by a method known to those skilled in the art, for example, may be measured by a particle size analyzer, or may be measured by a transmission electron micrograph and/or a scanning electron micrograph. In some embodiments, it is possible to obtain an average particle diameter value by measuring utilizing a dynamic light scattering method, performing data analysis, counting the number of particles for each particle size range, and calculating from this. Unless otherwise defined, the average particle diameter may refer to the diameter (D50) of particles having a cumulative volume of 50 volume % in the particle size distribution.

Hereinafter, a more detailed configuration of a rechargeable lithium battery according to an embodiment of the present disclosure will be described.

### Electrolyte

An electrolyte for a rechargeable lithium battery according to an embodiment includes a non-aqueous organic solvent, a lithium salt, and an additive. The additive includes a fluorinated ketone and an Ag salt.

The electrolyte for a rechargeable lithium battery according to an embodiment includes a fluorinated ketone and an Ag salt and thus may have flame retardant characteristics, effectively suppress or reduce generation of lithium dendrite at the negative electrode, and improve safety and battery characteristics, when applied to a rechargeable lithium battery. For example, the electrolyte may improve overall performance of a battery to which a negative electrode with a high density of about 1.6 g/cc or more and a high voltage of about 4.5 V or more are applied and also, with a high-rate charging performance of about 3.0 C or so.

For example, because the fluorinated ketone has low viscosity, negative electrode impregnability of the electrolyte including the same may be improved. In some embodiments, the fluorinated ketone includes at least one fluorine atom in a compound and thus may secure flame retardant characteristics. Accordingly, a rechargeable lithium battery including the same may have improved safety.

In some embodiments, because the Ag salt improves conductivity of lithium ions in the rechargeable lithium battery, the lithium ions may effectively migrate even at a negative electrode with high density and thus suppress or reduce generation of lithium dendrite. Accordingly, high-temperature cycle-life characteristics and stability of a rechargeable lithium battery utilizing the electrolyte including the Ag salt may be improved.

### Fluorinated Ketone

The fluorinated ketone is a compound having a ketone group, and may be referred to as a ketone compound including fluorine by replacing at least one hydrogen by a fluorine atom. The fluorinated ketone may be, for example. represented by Chemical Formula 1.

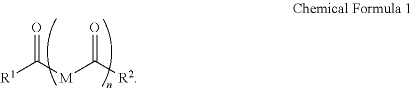

In Chemical Formula 1,
M may be a substituted or unsubstituted C1 to C30 alkylene group, a substituted or unsubstituted C2 to C30 alkenylene group, or a substituted or unsubstituted C2 to C30 alkynylene group,
R¹ and R² may each independently be a substituted or unsubstituted C1 to C30 alkyl group, a substituted or unsubstituted C2 to C30 alkenyl group, a substituted or unsubstituted C2 to C30 alkynyl group, a substituted or unsubstituted C3 to C20 cycloalkyl group, or a substituted or unsubstituted C6 to C20 aryl group, provided that at least one of R¹ or R² includes at least one fluorine atom, and n is an integer of 0 to 5.

In Chemical Formula 1, M may be, for example, a substituted or unsubstituted C1 to C30 alkylene group, for example, a substituted or unsubstituted C1 to C20 alkylene group, a substituted or unsubstituted C1 to C10 alkylene group, a substituted or unsubstituted C1 to C6 alkylene group, a substituted or unsubstituted C1 to C5 alkylene group, or a substituted or unsubstituted C1 to C4 alkylene group. For example, in Chemical Formula 1, M may be a C1 to C10 fluoroalkylene group in which at least one hydrogen is substituted with a fluorine atom.

In Chemical Formula 1, n may be any one of an integer from 0 to 5, for example, any one of an integer from 0 to 4, any one of an integer from 0 to 3, and any one of an integer from 0 to 2, and for example, 0 or 1.

In Chemical Formula 1, R¹ and R² may each independently be, for example, a substituted or unsubstituted C1 to C30 alkyl group, a substituted or unsubstituted C2 to C30 alkenyl group, or a substituted or unsubstituted C2 to C30 alkynyl group. For example, R¹ and R² may each independently be a substituted or unsubstituted C1 to C30 alkyl group, for example, a substituted or unsubstituted C1 to C20 alkyl group, a substituted or unsubstituted C1 to C10 alkyl group, a substituted or unsubstituted C1 to C6 alkyl group, a substituted or unsubstituted C1 to C5 alkyl group, a substituted or unsubstituted C1 to C4 alkyl group, or a substituted or unsubstituted C1 to C3 alkyl group. Herein, the alkyl group may be a straight chain or branched alkyl group. In Chemical Formula 1, at least one of R¹ or R² may be a C1 to C10 fluoroalkylene group in which at least one hydrogen is substituted with a fluorine atom. At least one of R¹ or R² may refer to only R¹, only R², or both (e.g., simultaneously) R¹ and R². In one example, both (e.g., simultaneously) R¹ and R² may each independently be a C1 to C10 fluoroalkylene group in which at least one hydrogen is substituted with a fluorine atom.

In the C1 to C10 fluoroalkylene group in which one or more hydrogens are substituted with a fluorine atom, the number of fluorine substitutions may be, for example, 1 to 21, 2 to 21, 3 to 21, 4 to 21, 5 to 21, and/or the like. For example, C1 to C10 fluoroalkylene group in which at least one hydrogen is substituted with fluorine may be a C1 to C10 fluoroalkylene group in which hydrogens (e.g., 3 to 21 hydrogen atoms) are substituted with 3 to 21 fluorine atoms.

In Chemical Formula 1, at least one of R¹ or R² may be a C1 to C10 perfluoroalkylene group in which all hydrogens are substituted with fluorine atoms, and may be, for example, a C1 to C6 perfluoroalkylene group or a C2 to C5 perfluoroalkylene group. In one example, both (e.g., simultaneously) R¹ and R² may each independently be a C1 to C10 perfluoroalkylene group. In an embodiment, when a fluorinated ketone including a perfluoroalkylene group is utilized, it is possible to improve electrolyte impregnability, improve battery flame retardancy, and/or improve overall battery performance.

In Chemical Formula 1, R¹ and R² may be the same as or different from each other. In one example, R¹ and R² may each be a C1 to C10 perfluoroalkylene group, but may be different from each other. In this case, high-rate charging performance at high voltage may be improved while ensuring battery flame retardancy.

As a specific example, the fluorinated ketone may be represented by Chemical Formula 1-1. Chemical Formula 1-1 may be referred to as a case where n is 0 in Chemical Formula 1.

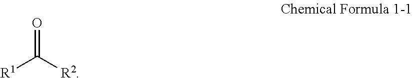

In Chemical Formula 1-1, R¹ and R² may each independently be a substituted or unsubstituted C1 to C30 alkyl group, and at least one of R¹ or R² includes one or more fluorine atoms.

For example, R¹ and R² may each independently be a C1 to C20 fluoroalkyl group substituted with at least one fluorine atom. For example, the term “fluoroalkyl group” refers to one in which all or a portion of the hydrogens of an ethylene group, propyl group, butyl group, pentyl group, hexyl group, heptyl group, octyl group, nonyl group, and/or decyl group are substituted with fluorine atom(s). For example, all hydrogens of the ethylene group may be substituted with fluorine atoms. The term “alkyl group” includes all structural isomers. For example, the propyl group includes an n-propyl group and an iso-propyl group, and the butyl group includes an n-butyl group, an iso-butyl group, a sec-butyl group, and a tert-butyl group.

In some embodiments, the fluoroalkyl group includes those in which all or a portion of the hydrogens among the aforementioned alkyl groups are substituted with fluoroalkyl groups. For example, one of the hydrogens of ethylene may be substituted with a trifluoromethyl group and all of the remaining hydrogens may be substituted with fluorine atoms. For example, two of the hydrogens of ethylene may be substituted with trifluoromethyl groups, and all of the remaining hydrogens may be substituted with fluorine atoms, but the present disclosure is not limited thereto.

In Chemical Formula 1-1, R¹ and R² may be the same as or different from each other. In one example, R¹ and R² of Chemical Formula 1-1 may be different from each other, and thus the compound represented by Chemical Formula 1-1 may have an asymmetric structure. In this case, it is possible to further improve high-rate charging performance at high voltage while securing flame retardancy of the battery.

The fluorinated ketone represented by Chemical Formula 1-1 may be, for example, represented by any one of Chemical Formulas 1-2 and 1-3.

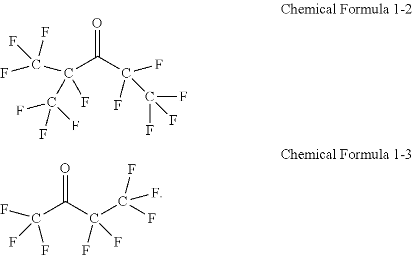

The fluorinated ketone may be included in an amount of about 1.0 wt % to about 10.0 wt % based on the total weight of the electrolyte for a rechargeable lithium battery. For example, it may be included in an amount of greater than or equal to about 1.5 wt %, for example, greater than or equal to about 2.0 wt %, for example, greater than or equal to about 2.5 wt %, for example, greater than or equal to about 3.0 wt %, for example, greater than or equal to about 3.5 wt %, or for example, greater than or equal to about 4.0 wt % and for example, less than or equal to about 10.0 wt %, for example, less than or equal to about 9.0 wt %, for example, less than or equal to about 8.5 wt %, for example, less than or equal to about 8.0 wt %, for example, less than or equal to about 7.5 wt %, or for example, less than or equal to about 7.0 wt %, but the present disclosure is not limited thereto. When the fluorinated ketone is included within the above ranges in the electrolyte according to an embodiment, flame retardant characteristics may be imparted to the electrolyte and impregnability of the negative electrode of the electrolyte may be improved.

### Ag Salt

The Ag salt included in the electrolyte for a rechargeable lithium battery according to an embodiment refers to a compound including an Ag cation and an anion paired with the Ag cation, and may include a nitrate ion, a carbonate ion, a sulfate ion, a chloride ion, and/or a sulfide ion as the anion.

The Ag salt may include, for example, one or more selected from AgNO₃, AgPF₆, AgFSI, AgTFSI, AgF, AgSO₃CF₃, AgBF₄, AgNO₂, AgN₃, and AgCN. For example, the Ag salt may be silver nitrate, silver carbonate, or silver sulfate, for example, silver nitrate. In the case of the silver nitrate, it can be effectively dissolved in an electrolyte, and is desirable (e.g., advantageous) in suppressing lithium dendrites generated in a high-density negative electrode by improving lithium ion conductivity in the negative electrode. However, the present disclosure is not limited to silver nitrate, and any suitable compound that is soluble in an electrolyte and includes Ag cations may be utilized as the Ag salt.

The Ag salt may be included in an amount of about 0.1 wt % to about 10.0 wt % based on the total weight of the electrolyte for a rechargeable lithium battery. For example, it may be included in an amount of greater than or equal to about 0.10 wt %, for example, of greater than or equal to about 0.20 wt %, for example, of greater than or equal to about 0.30 wt %, for example, of greater than or equal to about 0.40 wt %, for example, of greater than or equal to about 0.50 wt %, for example, of greater than or equal to about 1.0 wt %, for example, of greater than or equal to about 2.0 wt %, or for example, of greater than or equal to about 3.0 wt %, and for example, less than or equal to about 10.0 wt %, for example, less than or equal to about 9.0 wt %, for example, less than or equal to about 8.5 wt %, for example, less than or equal to about 8.0 wt %, for example, less than or equal to about 7.5 wt %, or for example, less than or equal to about 7.0 wt %, but the present disclosure is not limited thereto. By including the Ag salt within the above ranges in the electrolyte according to an embodiment, generation of dendrite in a negative electrode in a battery including the Ag salt may be suppressed or reduced.

A content (e.g., amount) ratio of the fluorinated ketone and the Ag salt may be about 4:6 to about 9:1, for example, 1:1, for example, about 2:1, for example, about 3:1, but the present disclosure is not limited to these.

Compound represented by Chemical Formula 2

The electrolyte for a rechargeable lithium battery according to another embodiment may further include a compound represented by Chemical Formula 2.

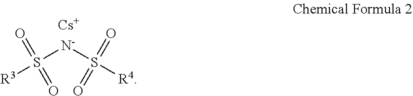

In Chemical Formula 2, R³ and R⁴ may each independently be a fluoro group, or a substituted C1 to C10 fluoroalkyl group including at least one fluorine atom.

For example, R³ and R⁴ of Chemical Formula 2 may each independently be a fluoro group, or a C1 to C4 fluoroalkyl group substituted with at least three fluoro groups. As a specific example, R³ and R⁴ of Chemical Formula 2 may each independently be a fluoro group, or a C1 to C3 fluoroalkyl group substituted with at least three fluoro groups.

As a more specific example, R³ and R⁴ of Chemical Formula 2 may each independently be a fluoro group, or a C1 to C2 fluoroalkyl group substituted with at least three fluoro groups.

Because the electrolyte for a rechargeable lithium battery according to an embodiment includes the compound represented by Chemical Formula 2, the compound is decomposed in the electrolyte and forms a film on the surfaces of the positive and negative electrodes to effectively control elution of lithium ions generated from the positive electrode and thus prevent or reduce decomposition of the positive electrode. For example, the compound represented by Chemical Formula 2 may be reduced and decomposed earlier than a carbonate-based solvent included in a non-aqueous organic solvent and thus form an SEI (Solid Electrolyte Interface) film on the negative electrode to prevent or reduce decomposition of the electrolyte and also the resulting decomposition reaction of the electrode, suppressing an increase in internal resistance due to generation of gas. The SEI film formed on the negative electrode is partially decomposed through a reduction reaction during charging and discharging and migrates to the surface of the positive electrode and thus forms a film on the positive electrode surface through an oxidation reaction to prevent or reduce decomposition of the positive electrode surface and an oxidation reaction of the electrolyte, resultantly contributing to improvement of high temperature and low temperature cycle-life characteristics.

In other words, the electrolyte includes the compound represented by Chemical Formula 2 and thus may improve cycle-life characteristics and safety of a battery.

Chemical Formula 2 may be, for example, represented by Chemical Formula 2-1 or Chemical Formula 2-2.

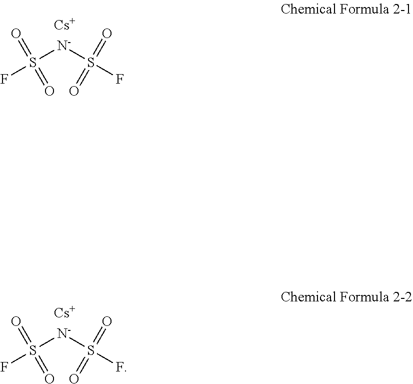

The compound represented by Chemical Formula 2 may be included in an amount of about 0.1 wt % to about 5.0 wt % based on the total weight of the electrolyte for a rechargeable lithium battery. For example, it may be included in an amount of greater than or equal to about 0.10 wt %, for example, greater than or equal to about 0.20 wt %, for example, greater than or equal to about 0.25 wt %, for example, greater than or equal to about 0.30 wt %, or for example, greater than or equal to about 0.35 wt %, and for example, less than or equal to about 5.0 wt %, for example, less than or equal to about 4.0 wt %, for example, less than or equal to about 3.0 wt %, for example, less than or equal to about 2.0 wt %, or for example, less than or equal to about 1.0 wt %, but the present disclosure is not limited thereto.

By including the compound represented by Chemical Formula 2 within the above ranges in the electrolyte according to an embodiment, an increase in internal resistance of the battery due to decomposition of the electrolyte may be suppressed or reduced, and cycle-life characteristic and safety of the battery may be improved.

A weight ratio of the fluorinated ketone and the compound represented by Chemical Formula 2 may be about 4:6 to about 9:1, for example, about 1:1, for example, about 2:1, for example, about 3:1, but the present disclosure is not limited thereto.

The electrolyte for a rechargeable lithium battery according to an embodiment further includes other additives. The other additives may include at least one selected from vinylene carbonate (VC), fluoroethylene carbonate (FEC), difluoroethylene carbonate (DFEC), chloroethylene carbonate (CEC), dichloroethylene.

carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propene sultone (PST), propane sultone (PS), lithium tetrafluoroborate (LiBF₄), lithium difluorophosphate (LiPO₂F₂), 2-fluorobiphenyl (2-FBP), lithium difluorooxalate borate (LiDFOB), and lithium bisoxalate borate (LiBOB).

The additives may be included in an amount of about 1.0 wt % to about 30.0 wt % based on the total weight of the electrolyte for a rechargeable lithium battery. For example, it may be included in an amount of greater than or equal to about 1.0 wt %, for example, greater than or equal to about 2.0 wt %, for example, greater than or equal to about 3.0 wt %, for example, greater than or equal to about 4.0 wt %, or for example, greater than or equal to about 5.0 wt %, and for example, less than or equal to about 30.0 wt %, for example, less than or equal to about 25.0 wt %, for example, less than or equal to about 20.0 wt %, for example, less than or equal to about 18.0 wt %, for example, less than or equal to about 16.0 wt %, or for example, less than or equal to about 15.0 wt %, but the present disclosure is not limited thereto. By including the additive within the above ranges in the electrolyte according to an embodiment, high-rate charging performance, high-temperature cycle-life characteristics, and stability of a rechargeable lithium battery including the additives may be improved.

The other additives may be included in an amount of for example, about 0.1 wt % to about 30.0 wt %, about 1.0 wt % to about 20.0 wt %, or about 2.0 wt % to about 15.0 wt % based on the total weight of the electrolyte for a rechargeable lithium battery. For example, the other additives may be included in an amount of greater than or equal to about 1.0 wt %, for example, greater than or equal to about 2.0 wt %, for example, greater than or equal to about 3.0 wt %, for example, greater than or equal to about 4.0 wt %, or for example, greater than or equal to about 5.0 wt %, and for example, less than or equal to about 30.0 wt %, for example, less than or equal to about 25.0 wt %, for example, less than or equal to about 20.0 wt %, for example, less than or equal to about 18.0 wt %, for example, less than or equal to about 16.0 wt %, or for example, less than or equal to about 15.0 wt %, but the present disclosure is not limited thereto. By including other additives within the above ranges in the electrolyte according to an embodiment, high-rate charging performance, high-temperature cycle-life characteristics, and stability of a rechargeable lithium battery including the additives may be improved.

### Non-Aqueous Organic Solvent

The non-aqueous organic solvent serves as a medium for transmitting ions taking part in the electrochemical reaction of a battery.

The non-aqueous organic solvent may be a carbonate-based, ester-based, ether-based, ketone-based, or alcohol-based solvent, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, t-butyl acetate, methyl propionate, ethyl propionate, propyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. In some embodiments, the ketone-based solvent may be cyclohexanone, and/or the like. In some embodiments, the alcohol-based solvent may be ethanol, isopropyl alcohol, and/or the like, and the aprotic solvent may be nitriles such as R—CN (where R is a C2 to C20 linear, branched, or cyclic hydrocarbon group, and may include a double bond, an aromatic ring, and/or an ether bond), and/or the like, amides such as dimethyl formamide, dioxolanes such as 1,3-dioxolane, sulfolanes, and/or the like

The non-aqueous organic solvent may be utilized alone or in a mixture. When the organic solvent is utilized in a mixture, the mixing ratio may be controlled or selected in accordance with a desirable battery performance.

In some embodiments, in the case of the carbonate-based solvent, a mixture of a cyclic carbonate and a chain carbonate may be utilized. In this case, when the cyclic carbonate and the chain carbonate are mixed in a volume ratio of about 1:1 to about 1:9, the electrolyte may exhibit excellent or suitable performance.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula 3 may be utilized.

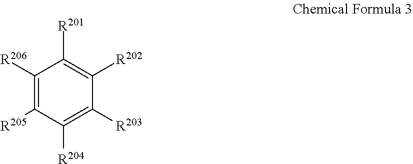

In Chemical Formula 3, R²⁰¹ to R²⁰⁶ may be the same or different and may each independently be hydrogen, a halogen, a C1 to C10 alkyl group, a haloalkyl group, or a combination thereof.

Specific non-limiting examples of the aromatic hydrocarbon-based solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate or an ethylene carbonate-based compound of Chemical Formula 4 in order to improve cycle-life of a battery.

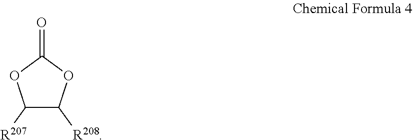

In Chemical Formula 4, R²⁰⁷ and R²⁰⁸ may be the same or different, and may each independently be selected from hydrogen, a halogen, a cyano group (CN), a nitro group (NO₂), and a fluorinated C1 to C5 alkyl group.

Examples of the ethylene-based carbonate-based compound may include (e.g., may be) difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. An amount of the additive for improving cycle-life may be utilized within an appropriate or suitable range.

### Lithium Salt

The lithium salt dissolved in the non-aqueous organic solvent supplies lithium ions in a battery, enables a basic operation of a rechargeable lithium battery, and improves transportation of the lithium ions between positive and negative electrodes.

Examples of the lithium salt may include at least one selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), LiC₄F₉SO₃, LiClO₄, LiAlO₂, LiAlCl₄, LiPO₂F₂, LiN(CₓF₂ₓ₊₁SO₂)(C_{y}F_{2y+1} SO₂), wherein x and y are natural numbers, for example, an integer in a range of 1 to 20, lithium difluoro(bisoxalato) phosphate, LiCl, Lil, LiB(C₂O₄)₂ (lithium bis(oxalato) borate, LiBOB), and lithium difluoro(oxalato)borate (LiDFOB).

The lithium salt may be utilized in a concentration in a range of about 0.1 M to about 2.0 M. When the lithium salt is included at the above concentration range, an electrolyte may have excellent or suitable performance and lithium ion mobility due to optimal or suitable electrolyte conductivity and viscosity.

### Rechargeable Lithium Battery

The additive and the electrolyte may be applied to a rechargeable lithium battery.

A rechargeable lithium battery according to an embodiment includes a positive electrode including a positive electrode active material; a negative electrode including a negative electrode active material; a separator between the positive electrode and the negative electrode; and the aforementioned electrolyte.

The rechargeable lithium battery may be classified into a lithium ion battery, a lithium ion polymer battery, or a lithium polymer battery according to the presence of a separator and the type or kind of electrolyte utilized therein, may be classified into a cylindrical, prismatic, coin, or pouch-type or kind according to the shape, and may be classified into a bulk type or kind or a thin film type or kind according to the size. Structures and manufacturing methods for the batteries are known in the art and thus detailed descriptions thereof are omitted.

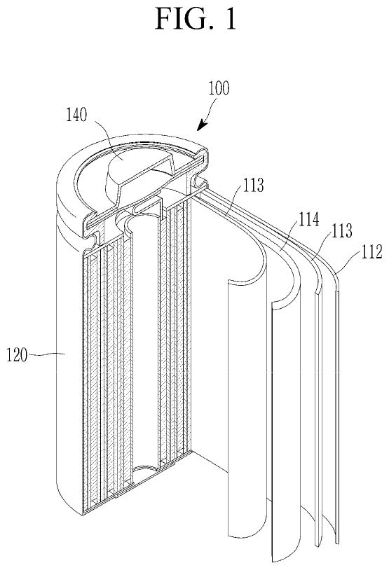

Here, as an example of the rechargeable lithium battery, a cylindrical rechargeable lithium battery will be described. FIG. 1 schematically illustrates the structure of a rechargeable lithium battery according to an embodiment. Referring to FIG. 1, a rechargeable lithium battery 100 according to an embodiment includes a battery cell including a positive electrode 114, a negative electrode 112 facing the positive electrode 114, a separator 113 between the positive electrode 114, an electrolyte impregnating the positive electrode 114, the negative electrode 112, and the separator 113, a battery case 120 containing the battery cell, and a sealing member 140 sealing the battery case 120.

### Positive Electrode

The positive electrode includes a positive electrode current collector and a positive electrode active material layer on the positive electrode current collector, and the positive electrode active material layer includes a positive electrode active material.

As the positive electrode active material, a compound (lithiated intercalation compound) being capable of intercalating and deintercalating lithium may be utilized, and for example, a compound represented by any one of the following chemical formulas may be included.

LiₐA_{1-b}X_{b}D₂ (0.90≤a≤1.8, 0≤b≤0.5);

LiₐA_{1-b}X_{b}O_{2-c}D_{c} (0.90≤a≤1.8, 0≤b≤0.5, 0≤c≤0.05);

LiₐE_{1-b}X_{b}O_{2-c}D_{c} (0.90≤a≤1.8, 0≤b≤0.5, 0≤c≤0.05);

LiₐE_{2-b}X_{b}O_{4-c}D_{c} (0.90≤a≤1.8, 0≤b≤0.5, 0≤c≤0.05);

LiₐNi_{1-b-c}CO_{b}X_{c}D_{α} (0.90≤a≤0≤b≤0.5, 0≤c≤0.5, 0<α≤2);

LiₐNi_{1-b-c}CO_{b}X_{c}O_{2-α}T_{α} (0.90≤a≤1.8, 0≤b≤0.5, 0≤c≤0.05, 0<α≤2);

LiₐNi_{1-b-c}Co_{b}X_{c}O_{2-α}T₂ (0.90≤a≤1.8, 0≤b≤0.5, 0≤c≤0.05, 0<α<2);

LiₐNi_{1-b-c}Mn_{b}X_{c}D_{α} (0.90≤a≤1.8, 0≤b≤0.5, 0≤c≤0.05, 0<α≤2);

LiₐNi_{1-b-c}Mn_{b}X_{c}O_{2-α}T_{α} (0.90≤a≤1.8, 0≤b≤0.5, 0≤c≤0.05, 0<α<2);

LiₐNi_{1-b-c}Mn_{b}X_{c}O_{2-α}T₂ (0.90≤a≤1.8, 0≤b≤0.5, 0≤c≤0.05, 0<α<2);

LiₐNi_{b}E_{c}G_{d}O₂ (0.90≤a≤1.8, 0≤b≤0.9, 0≤c≤0.5, 0.001≤d≤0.1);

LiₐNi_{b}Co_{c}Mn_{d}Ge₂O₂ (0.90≤a≤1.8, 0≤b≤0.9, 0≤c≤0.5, 0≤d≤0.5, 0.001≤e≤0.1);

LiₐNiG_{b}O₂ (0.90≤a≤1.8, 0.001≤b≤0.1);

LiₐCoG_{b}O₂ (0.90≤a≤1.8, 0.001≤b≤0.1);

LiₐMn_{1-b}GbO₂ (0.90≤a≤1.8, 0.001≤b≤0.1);

LiₐMn₂GbO₄ (0.90≤a≤1.8, 0.001≤b≤0.1);

LiₐMn_{1-g} G_{g}PO₄ (0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂(PO₄)₃ (0≤f≤2);

Li_{(3-f)}Fe₂(PO₄)₃ (0≤f≤2); and

LiₐFePO₄ (0.90≤a≤1.8).

In the above chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), and/or lithium iron phosphate (LFP).

As the positive electrode active material, one having a coating layer on the surface of the composite oxide may be utilized, or a mixture of the composite oxide and the composite oxide having a coating layer may be utilized. The coating layer may include at least one coating element compound selected from an oxide of a coating element, a hydroxide of a coating element, an oxyhydroxide of a coating element, an oxycarbonate of a coating element, or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed through a method having no adverse influence on properties of a positive electrode active material by utilizing these elements in the compound. For example, the method may include any suitable coating method such as spray coating, dipping, and/or the like, but the coating method is not illustrated in more detail because it is known in the related field.

The positive electrode active material may be, for example, at least one of lithium composite oxides represented by Chemical Formula 5.

LiₓM¹_{y}M²_{z}M³_{1-y-z}O₂ Chemical Formula 5

In Chemical Formula 5,
0.5≤x≤1.8, 0<y≤1, 0≤z≤1, 0≤y+z≤1, and M¹, M², and M³ may each independently be a metal selected from Ni, Co, Mn, Al, Sr, Mg, La, and a combination thereof.

In an embodiment, the positive electrode active material may be at least one selected from LiCoO₂, LiNiO₂, LiMnO₂, LiMn₂O₄, LiNiₐMn_{b}Co_{c}O₂ (a+b+c=1), LiNiₐMn_{b}Co_{c}Al_{d}O₂ (a+b+c+d=1), and LiNiₑCo_{f}Al_{g}O₂ (e+f+g=1).

For example, the positive electrode active material selected from LiNiₐMn_{b}Co_{c}O₂ (a+b+c=1), LiNiₐMn_{b}Co_{c}Al_{d}O₂ (a+b+c+d=1), and LiNiₑCo_{f}Al_{g}O₂ (e+f+g=1) may be a high-Ni positive electrode active material.

For example, in the case of LiNiₐMn_{b}Co_{c}O₂ (a+b+c=1) and LiNiₐMn_{b}Co_{c}Al_{d}O₂ (a+b+c+d=1), the nickel content (e.g., amount) may be greater than or equal to about 60% (a≥0.6), and more specifically, greater than or equal to about 80% (a≥0.8).

For example, in the case of LiNiₑCo_{f}Al_{g}O₂ (e+f+g=1), the nickel content (e.g., amount) may be greater than or equal to about 60% (e≥0.6), and more specifically, greater than or equal to about 80% (e≥0.8).

An amount of the positive electrode active material may be about 90 wt % to about 98 wt % based on the total weight of the positive electrode active material layer.

The positive electrode active material layer may optionally include a conductive material and a binder. In this case, each content (e.g., amount) of the conductive material and the binder may be about 1.0 wt % to about 5.0 wt % based on the total weight of the positive electrode active material layer.

The conductive material is utilized to impart conductivity to the positive electrode, and in the configured battery, any suitable material that does not cause chemical change and is electronically conductive may be utilized. For example, the conductive material may be a carbon-based material such as natural graphite, artificial graphite, carbon black, acetylene black, ketjen black, a carbon fiber, a carbon nanofiber, and/or a carbon nanotube; a metal-based material such as a metal powder and/or a metal fiber including copper, nickel, aluminum, and/or silver; a conductive polymer such as a polyphenylene derivative; or a mixture thereof.

The binder improves binding properties of positive electrode active material particles with one another and with a current collector. Examples thereof may include (e.g., may be) polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but the present disclosure is not limited thereto.

The positive electrode current collector may include an aluminum foil or SUS foil, but the present disclosure is not limited thereto.

### Negative Electrode

The negative electrode includes a negative electrode current collector and a negative electrode active material layer including the negative electrode active material formed on the negative electrode current collector.

The negative electrode active material may include a material that reversibly intercalates/deintercalates lithium ions, a lithium metal, a lithium metal alloy, a material capable of doping/dedoping lithium, and/or transition metal oxide.

The material that reversibly intercalates/deintercalates lithium ions includes carbon materials. The carbon material may be any generally-utilized suitable carbon-based negative electrode active material in a rechargeable lithium battery. Examples of the carbon material may include crystalline carbon, amorphous carbon, and a combination thereof. The crystalline carbon may be non-shaped (e.g., irregularly shaped), or sheet, flake, spherical, or fiber shaped natural graphite or artificial graphite.

The amorphous carbon may be a soft carbon, a hard carbon, a mesophase pitch carbonized product, calcined coke, and/or the like.

The lithium metal alloy may include lithium and a metal selected from Na, K, Rb, Cs, Fr, Be, Mg, Ca, Sr, Si, Sb, Pb, In, Zn, Ba, Ra, Ge, Al, and Sn.

The material capable of doping and dedoping lithium may include Si, SiOdx (0<x<2), a Si-Q alloy (wherein Q is selected from an alkali metal, an alkaline-earth metal, a Group 13 element, a Group 14 element excluding Si, a Group 15 element, a Group 16 element, a transition metal, a rare earth element, and a combination thereof), Sn, SnO₂, a Sn—R alloy (wherein R is an alkali metal, an alkaline-earth metal, a Group 13 element, a Group 14 element excluding Sn, a Group 15 element, a Group 16 element, a transition element, a rare earth element, or a combination thereof), and/or the like. In an embodiment, at least one of them may be mixed with SiO₂.

The elements Q and R may be selected from Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The transition metal oxide may be a vanadium oxide, a lithium vanadium oxide, and/or the like.

In a specific embodiment, the anode active material may be a Si—C composite including a Si-based active material and a carbon-based active material.

An average particle diameter of the Si-based active material in the Si—C composite may be about 50 nm to about 200 nm. When the average particle diameter of the Si-based active material is within the above range, volume expansion occurring during charging and discharging may be suppressed or reduced, and a disconnection of a conductive path due to particle crushing during charging and discharging may be prevented or reduced. The Si-based active material may be included in an amount of about 1 wt % to about 60 wt %, for example, about 3 wt % to about 60 wt %, based on a total weight of the Si—C composite.

In another specific embodiment, the negative electrode active material may further include crystalline carbon together with the aforementioned Si—C composite.

When the negative electrode active material includes a Si—C composite and crystalline carbon together, the Si—C composite and crystalline carbon may be included in the form of a mixture, and in this case, the Si—C composite and crystalline carbon may be included in a weight ratio of about 1:99 to about 50:50. For example, the Si—C composite and crystalline carbon may be included in a weight ratio of about 5:95 to about 20:80.

The crystalline carbon may include, for example, graphite, and in some embodiments, may include natural graphite, artificial graphite, or a mixture thereof. The crystalline carbon may have an average particle diameter of about 5 μm to about 30 μm.

Herein, the average particle diameter may be a particle size (D50) at a volume ratio of 50% in a cumulative size-distribution curve.

The Si—C composite may further include a shell around (e.g., surrounding) the surface of the Si—C composite, and the shell may include amorphous carbon. The amorphous carbon may include soft carbon, hard carbon, a mesophase pitch carbonization product, calcined coke, or a mixture thereof.

The amorphous carbon may be included in an amount of about 1 to about 50 parts by weight, for example, about 5 to about 50 parts by weight, or about 10 to about 50 parts by weight, based on 100 parts by weight of the carbon-based active material.

In the negative electrode active material layer, the negative electrode active material may be included in an amount of about 95 wt % to about 99 wt % based on the total weight of the negative electrode active material layer.

In an embodiment, the negative electrode active material layer may include a binder, and optionally a conductive material. In the negative electrode active material layer, the amount of the binder may be about 1 wt % to about 5 wt % based on a total weight of the negative electrode active material layer. When the negative electrode active material layer further includes the conductive material, the negative electrode active material layer may include about 90 wt % to about 98 wt % of the negative electrode active material, about 1 wt % to about 5 wt % of the binder, and about 1 wt % to about 5 wt % of the conductive material.

The binder improves binding properties of negative electrode active material particles with one another and with a current collector. The binder may be a non-water-soluble binder, a water-soluble binder, or a combination thereof.

The non-water-soluble binder may include (e.g., may be) polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, an ethylenepropylene copolymer, polyethyleneoxide, polyvinylpyrrolidone, polyepichlorohydrine, polyphosphazene, polyacrylonitrile, polystyrene, ethylenepropylenedienecopolymer, polyvinylpyridine, chlorosulfonatedpolyethylene, latex, a polyester resin, an acrylic resin, a phenolic resin, an epoxy resin, polyvinyl alcohol, and a combination thereof.

When the water-soluble binder is utilized as the negative electrode binder, a cellulose-based compound may be further utilized to provide viscosity as a thickener. The cellulose-based compound may include carboxylmethyl cellulose, hydroxypropylmethyl cellulose, methyl cellulose, and/or an alkali metal salt thereof. The alkali metal may be Na, K, and/or Li. Such a thickener may be included in an amount of about 0.1 to about 3 parts by weight based on 100 parts by weight of the negative electrode active material.

The conductive material is utilized to impart conductivity to the electrode, and in the configured battery, any suitable material that does not cause chemical change and is electronically conductive may be utilized. For example, the conductive material may be a carbon-based material such as natural graphite, artificial graphite, carbon black, acetylene black, ketjen black, a carbon fiber, a carbon nanofiber, and/or a carbon nanotube; a metal-based material such as a metal powder and/or a metal fiber including copper, nickel, aluminum, and/or silver; a conductive polymer such as a polyphenylene derivative; or a mixture thereof.

The negative electrode current collector may be selected from a copper foil, a nickel foil, a stainless steel foil, a titanium foil, a nickel foam, a copper foam, a polymer substrate coated with a conductive metal, and a combination thereof.

### Separator

The separator 113 separates the positive electrode 114 and the negative electrode 112 and provides a passage for lithium ions to move through, and may be any suitable one commonly utilized in a lithium ion battery. The separator may have low resistance to ion movement of the electrolyte and excellent or suitable ability to absorb the electrolyte. For example, the separator may include a glass fiber, polyester, polyethylene, polypropylene, polytetrafluoroethylene, or a combination thereof, and may be in the form of a non-woven fabric or a woven fabric. For example, in lithium ion batteries, polyolefin-based polymer separators such as polyethylene and/or polypropylene are mainly utilized, and coated separators containing ceramic components or polymer materials may be utilized to secure heat resistance and/or mechanical strength.

The separator may be, for example, polyethylene, polypropylene, polyvinylidene fluoride, or a multilayer film of two or more layers thereof, and may be a mixed multilayer film such as a polyethylene/polypropylene two-layer separator, a polyethylene/polypropylene/polyethylene three-layer separator, a polypropylene/polyethylene/polypropylene three-layer separator, and/or the like.

The separator may include a functional layer on a porous substrate. The functional layer may be, for example, at least one of a heat resistant layer or an adhesive layer from the viewpoint of enabling additional functions. For example, the heat resistant layer may include a heat resistant resin and optionally a filler. In some embodiments, the adhesive layer may include an adhesive resin and optionally a filler. The filler may be an organic filler and/or an inorganic filler.

Hereinafter, the present disclosure is illustrated in more detail with reference to examples. However, these are examples, and the present disclosure is not limited thereto.

### Preparation of Electrolyte

### Comparative Preparation Example 1

Ethylene carbonate (EC), propylene carbonate (PC), and propylpropionate (PP) were mixed in a volume ratio of 10:15:75, and LiPF₆ was added thereto to prepare a 1.3 M mixed solution. Subsequently, 7 parts by weight of FEC, 1 part by weight of VEC, and 0.2 parts by weight of LiBF₄ based on 100 parts by weight of the mixed solution were added thereto, thereby preparing an electrolyte.

### Comparative Preparation Example 2

An electrolyte was prepared in substantially the same manner as in Comparative Preparation Example 1 except that 1 part by weight of the compound represented by Chemical Formula 1-2 as the fluorinated ketone based on 100 parts by weight of the mixed solution was added.

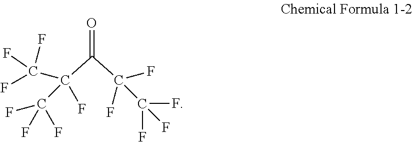 [SMILES: O=C(C(F)(F)C(F)(F)F)C(F)(C(F)(F)F)C(F)(F)F]

### Comparative Preparation Example 3

An electrolyte was prepared in substantially the same manner as in Comparative Preparation Example 1 except that 0.5 parts by weight of nitric acid based on 100 parts by weight of the mixed solution was added.

### Comparative Preparation Example 4

An electrolyte was prepared in substantially the same manner as in Comparative Preparation Example 1 except that 0.5 parts by weight of the compound represented by Chemical Formula 2-1 based on 100 parts by weight of the mixed solution was added.

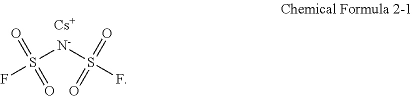

### Preparation Example 1

An electrolyte was prepared in substantially the same manner as in Comparative Preparation Example 1 except that 1 part by weight of the compound represented by Chemical Formula 1-2 as the fluorinated ketone and 0.5 parts by weight of nitric acid based on 100 parts by weight of the mixed solution were added.

### Preparation Example 2

An electrolyte was prepared in substantially the same manner as in Preparation Example 1 except that 0.5 parts by weight of the compound represented by Chemical Formula 2-1 as the fluorinated ketone and 0.5 parts by weight of nitric acid based on 100 parts by weight of the mixed solution were added.

### Manufacture of Rechargeable Lithium Battery Cells

### Example 1

### Manufacture of Negative Electrode

98 wt % of artificial graphite (BSG-L, Tianjin BTR New Energy Technology Co., Ltd.), 1.0 wt % of a styrene-butadiene rubber (SBR) binder (ZEON Chemicals L.P.), and 1.0 wt % of carboxylmethyl cellulose (CMC, NIPPON A&L) were mixed and added to distilled water and then, stirred for 60 minutes with a mechanical stirrer, thereby preparing a negative electrode active material slurry. The slurry was coated to be about 60 μm thick on a 10 μm-thick copper current collector with a doctor blade, dried at 100° C. with hot air for 0.5 hours, dried again under vacuum at 120° C. for 4 hours, and roll-pressed, thereby manufacturing a negative electrode plate. Herein, the negative electrode had a density of 1.6 g/cc.

### Manufacture of Positive Electrode

96 wt % of LiCoO₂, 2 wt % of carbon black (Ketjenblack, ECP) as a conductive material, and 2 wt % of polyvinylidene fluoride (PVdF, S6020, Solvay) as a binder were mixed in an N-methyl-2-pyrrolidone solvent and stirred for 30 minutes with a mechanical stirrer, thereby preparing a positive electrode active material slurry. The slurry was coated to be about 60 μm thick on a 20 μm-thick aluminum current collector with a doctor blade, dried at 100° C. with a hot air drier for 0.5 hours, dried again under vacuum at 120° C. for 4 hours, and roll-pressed, thereby manufacturing a positive electrode plate.

### Manufacture of Battery Cells

The manufactured positive and negative electrodes and a 25 μm-thick polyethylene separator were assembled to manufacture an electrode assembly, and the electrolyte of Preparation Example 1 was injected thereinto, thereby manufacturing a rechargeable lithium battery cell. The rechargeable lithium battery cell was operated at a voltage of 4.5 V and charged at 3.0 C.

### Example 2

A rechargeable lithium battery cell was manufactured in substantially the same manner as in Example 1 except that the electrolyte of Preparation Example 2 was utilized.

### Comparative Example 1

A rechargeable lithium battery cell was manufactured in substantially the same manner as in Example 1 except that the electrolyte of Comparative Preparation Example 1 was utilized, a negative electrode with density of 1.5 g/cc was utilized, and the cell was charged at 1.3 C.

### Comparative Example 2

A rechargeable lithium battery cell was manufactured in substantially the same manner as in Example 1 except that the electrolyte of Comparative Preparation Example 1 was utilized, and the cell was charged at 1.3 C.

### Comparative Example 3

A rechargeable lithium battery cell was manufactured in substantially the same manner as in Example 1 except that the electrolyte of Comparative Preparation Example 1 was utilized.

### Comparative Example 4

A rechargeable lithium battery cell was manufactured in substantially the same manner as in Example 1 except that the electrolyte of Comparative Preparation Example 2 was utilized.

### Comparative Example 5

A rechargeable lithium battery cell was manufactured in substantially the same manner as in Example 1 except that the electrolyte of Comparative Preparation Example 3 was utilized.

### Comparative Example 6

A rechargeable lithium battery cell was manufactured in substantially the same manner as in Example 1 except that the electrolyte of Comparative Preparation Example 4 was utilized.

Each additive composition of the rechargeable lithium battery cells according to Examples 1 to 2, and Comparative Examples 1 to 6 is shown in Table 1.

TABLE 1

| | Negative | | Compositions of Electrolyte | | |
|---|---|---|---|---|---|
| | electrode | | PMP | AgNO₃ | CsFSI |
| | density | Charging | (parts by | (parts by | (parts by |
| | (g/cc) | rate | weight) | weight) | weight) |
| Comp. Ex. 1 | 1.5 | 1.3 C | — | — | — |
| Comp. Ex. 2 | 1.6 | 1.3 C | — | — | — |
| Comp. Ex. 3 | | 3.0 C | — | — | — |
| Comp. Ex. 4 | | | 1 | — | — |
| Comp. Ex. 5 | | | — | 0.5 | — |
| Comp. Ex. 6 | | | — | — | 0.5 |
| Ex. 1 | | | 1 | 0.5 | — |
| Ex. 2 | | | 1 | 0.5 | 0.5 |

### Evaluation 1: Evaluation of Dendrite Generation

A LiCoO₂ positive electrode, a graphite negative electrode, a separator were utilized to manufacture a 2032 coin cell, and the cell was charged at 4.6 V (CC/CV 0.2 C 4.6 V, 0.05 C cutoff) and disassembled to take (e.g., remove) the negative electrode, which was examined with respect to whether or not lithium dendrite was generated. The results are shown in Table 2.

TABLE 2

| | Whether lithium dendrite is |
|---|---|
| | generated or not |
| Comp. Ex. 1 | X |
| Comp. Ex. 2 | X |
| Comp. Ex. 3 | ◯ |
| Comp. Ex. 4 | ◯ |
| Comp. Ex. 5 | ◯ |
| Comp. Ex. 6 | ◯ |
| Ex. 1 | X |
| Ex. 2 | X |

Referring to Table 2, in the rechargeable lithium battery cells of Examples 1 and 2 were suppressed or reduced from generation of lithium dendrite, but in the cells of each of Comparative Examples 3 to 6, having the same negative electrode density and charging speed as the examples, lithium dendrite was generated. Accordingly, the rechargeable lithium battery cells according to the examples utilized the electrolyte according to an embodiment and thus generation of lithium dendrite was suppressed or reduced and safety of the cells was improved.

### Evaluation 2: Evaluation of High-Temperature Cycle-Life Characteristics

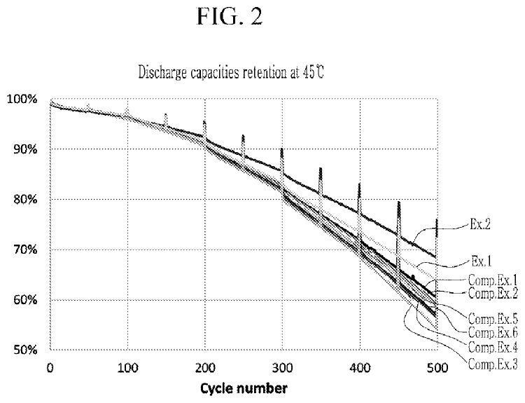

The rechargeable lithium battery cells according to Examples 1 to 2 and Comparative Examples 3 to 6 were constant current charged to 4.5 V at a charge rate of 3.0 C and subsequently, constant current discharged to a voltage of 3.0 V at a high temperature of 45° C., wherein the charge and discharge were 500 cycles repeated to measure discharge capacity, which was utilized to calculate discharge capacity retention and thus evaluate high-temperature cycle-life characteristics of the cells. The measured discharge capacities are shown in Table 3, and discharge capacity retention changes according to charge and discharge cycles are shown in FIG. 2.

TABLE 3

| | 4.5 V high temperature cycle- |
|---|---|
| | life @ 500 cycles (%) |
| Comp. Ex. 3 | 55 |
| Comp. Ex. 4 | 57 |
| Comp. Ex. 5 | 59 |
| Comp. Ex. 6 | 57 |
| Example 1 | 64 |
| Example 2 | 69 |

Referring to Table 3 and FIG. 2, the rechargeable lithium battery cells of Examples 1 and 2 exhibited excellent or suitable discharge capacity retentions, compared with the rechargeable lithium battery cells of Comparative Examples 3 to 6. Because fluorinated ketone and Ag salt were concurrently (e.g., simultaneously) utilized as an electrolyte additive according to an embodiment, high-rate charging performance under high density and high voltage conditions turned out to be improved.

In the present application, when particles are spherical, “diameter” indicates a particle diameter or an average particle diameter, and when the particles are non-spherical, the “diameter” indicates a major axis length or an average major axis length.

As used herein, the singular forms “a”, “an” and “the” are intended to include the plural forms as well, unless the context clearly indicates otherwise.

While the present disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims, and equivalents thereof.

### DESCRIPTION OF SYMBOLS

100: rechargeable lithium battery
112: negative electrode
113: separator
114: positive electrode
120: battery case
140: sealing member

What is claimed is:

1. An electrolyte for a rechargeable lithium battery, the electrolyte comprising:
a non-aqueous organic solvent;
a lithium salt; and
an additive,
wherein the additive comprises a fluorinated ketone and an Ag salt.

2. The electrolyte of claim 1, wherein the fluorinated ketone is represented by Chemical Formula 1: 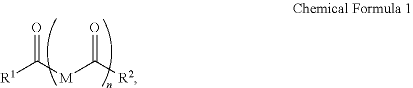
wherein, in Chemical Formula 1,
M is a substituted or unsubstituted C1 to C30 alkylene group, a substituted or unsubstituted C2 to C30 alkenylene group, or a substituted or unsubstituted C2 to C30 alkynylene group,
n is an integer of 0 to 5, and
R¹ and R² are each independently a substituted or unsubstituted C1 to C30 alkyl group, a substituted or unsubstituted C2 to C30 alkenyl group, a substituted or unsubstituted C2 to C30 alkynyl group, a substituted or unsubstituted C3 to C20 cycloalkyl group, or a substituted or unsubstituted C6 to C20 aryl group, provided that at least one of R¹ or R² comprises at least one fluorine atom.

3. The electrolyte of claim 2, wherein, in Chemical Formula 1,
M is a substituted or unsubstituted C1 to C10 alkylene group,
R¹ and R² are each independently a substituted or unsubstituted C1 to C10 alkyl group, a substituted or unsubstituted C2 to C10 alkenyl group, or a substituted or unsubstituted C2 to C10 alkynyl group, provided that at least one of R¹ or R² comprises at least one fluorine atom, and
n is 0 or 1.

4. The electrolyte of claim 2, wherein at least one of R¹ or R² in Chemical Formula 1 is a C1 to C10 fluoroalkylene group in which at least one hydrogen is substituted with a fluorine atom.

5. The electrolyte of claim 2, wherein at least one of R¹ or R² in Chemical Formula 1 is a C1 to C10 fluoroalkylene group substituted with 3 to 21 fluorine atoms.

6. The electrolyte of claim 2, wherein at least one of R¹ or R² in Chemical Formula 1 is a C1 to C10 perfluoroalkylene group in which all hydrogens are substituted with fluorine atoms.

7. The electrolyte of claim 1, wherein the fluorinated ketone is represented by Chemical Formula 1-1: 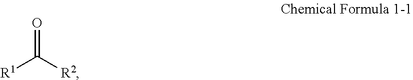
wherein, in Chemical Formula 1-1,
R¹ and R² are each independently a substituted or unsubstituted C1 to C30 alkyl group, provided that at least one of R¹ or R² comprises at least one fluorine atom.

8. The electrolyte of claim 7, wherein
at least one of R¹ or R² in Chemical Formula 1-1 is a C1 to C10 perfluoroalkyl group in which all hydrogens are substituted with fluorine atoms.

9. The electrolyte of claim 7, wherein
R¹ and R² in Chemical Formula 1-1 are functional groups different from each other and Chemical Formula 1-1 has an asymmetric structure.

10. The electrolyte of claim 1, wherein the fluorinated ketone is represented by Chemical Formula 1-2 or Chemical Formula 1-3:

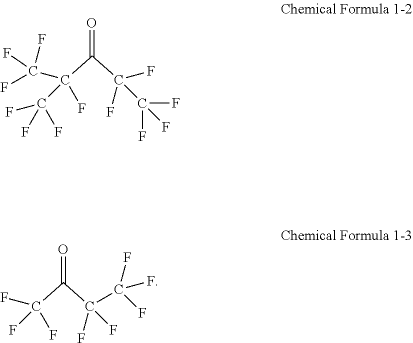 [SMILES: O=C(C(F)(F)C(F)(F)F)C(F)(C(F)(F)F)C(F)(F)F ; O=C(C(F)(F)F)C(F)(F)C(F)(F)F]

11. The electrolyte of claim 1, wherein the fluorinated ketone is about 1.0 wt % to about 10.0 wt % in amount based on a total weight of the electrolyte.

12. The electrolyte of claim 1, wherein the Ag salt comprises one or more selected from the group consisting of AgNO₃, AgPF₆, AgFSI, AgTFSI, AgF, AgSO₃CF₃, AgBF₄, AgNO₂, AgN₃, and AgCN.

13. The electrolyte of claim 1, wherein the Ag salt is about 0.1 wt % to about 10.0 wt % in amount based on a total weight of the electrolyte.

14. The electrolyte of claim 1, wherein a weight ratio between the fluorinated ketone and the Ag salt is about 4:6 to about 9:1.

15. The electrolyte of claim 1, wherein the additive further comprises a compound represented by Chemical Formula 2: 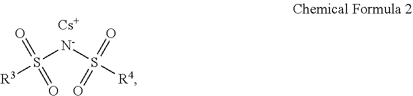
wherein, in Chemical Formula 2,
R³ and R⁴ are each independently a fluoro group or a substituted C1 to C10 fluoroalkyl group comprising at least one fluorine atom.

16. The electrolyte of claim 15, wherein the compound represented by Chemical Formula 2 is represented by Chemical Formula 2-1 or Chemical Formula 2-2.

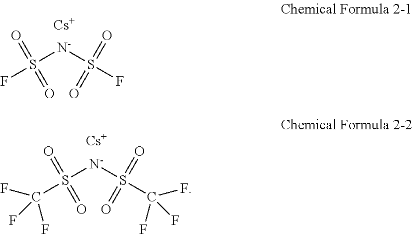

17. The electrolyte of claim 15, wherein the compound represented by Chemical Formula 2 is about 0.1 wt % to about 5.0 wt % in amount based on a total weight of the electrolyte.

18. The electrolyte of claim 15, wherein a weight ratio between the fluorinated ketone and the compound represented by Chemical Formula 2 is about 4:6 to about 9:1.

19. The electrolyte of claim 1, wherein the additive is about 1.0 wt % to about 30.0 wt % in amount based on a total weight of the electrolyte.

20. The electrolyte of claim 1, wherein
the electrolyte further comprises one or more other additives, and
the one or more other additives comprise at least one selected from the group consisting of vinylene carbonate (VC), fluoroethylene carbonate (FEC), difluoroethylene carbonate (DFEC), chloroethylene carbonate (CEC), dichloroethylene. carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propene sultone (PST), propane sultone (PS), lithium tetrafluoroborate (LiBF₄), lithium difluorophosphate (LiPO₂F₂), 2-fluorobiphenyl (2-FBP), lithium difluorooxalate borate (LiDFOB), and lithium bisoxalate borate (LiBOB).

21. A rechargeable lithium battery, comprising:
a positive electrode comprising a positive electrode active material;
a negative electrode comprising a negative electrode active material;
a separator between the positive electrode and the negative electrode; and
the electrolyte of claim 1.

22. The rechargeable lithium battery of claim 21, wherein the negative electrode has a density of greater than or equal to about 1.6 g/cc.
